(19) United States
(12) Patent Application Publication
(10) Pub. No.: US 2016/0056455 A1
(43) Pub. Date: Feb. 25, 2016

(54) STRUCTURE EQUIPPED WITH AMORPHOUS CARBON FILM HAVING ELECTRICALLY CONDUCTIVE PART AND CONTAINING SILICON, AND METHOD FOR MANUFACTURING SAME

(71) Applicant: TAIYO CHEMICAL TECHNOLOGY CO., LTD., Takasaki-shi, Gunma (JP)

(72) Inventor: Kunihiko Shibusawa, Takasaki-shi, Gunma (JP)

(21) Appl. No.: 14/779,152

(22) PCT Filed: Mar. 31, 2014
(86) PCT No.: PCT/JP2014/059442

§ 371 Date: Sep. 22, 2015

(30) Foreign Application Priority Data
Apr. 2, 2013 (JP) 2013-077182

(51) Int. Cl. H01M 4/36; H01M 4/134; H01M 4/1395; H01M 4/587; H01M 4/1393; H01M 4/133; H01M 4/38

(52) U.S. Cl. CPC H01M 4/366; H01M 4/133; H01M 4/134; H01M 4/386; H01M 4/587; H01M 4/1393; H01M 4/1395

(57) ABSTRACT

In a structure according to an embodiment, an electrically conductive part on an amorphous carbon film can be appropriately formed, and the region surrounding the electrically conductive part of the amorphous carbon film can have increased friction resistance and wear resistance. The structure includes a substrate and an amorphous carbon film containing Si formed on the substrate and irradiated with a laser beam to have an electrically conductive part modified to have electric conductivity.

### CROSS-REFERENCE TO RELATED APPLICATIONS

This application is based on and claims the benefit of priority from Japanese Patent Application Serial No. 2013-077182 (filed on Apr. 2, 2013), the contents of which are hereby incorporated by reference in their entirety.

### TECHNICAL FIELD

The present invention relates to a structure and a method of manufacturing the same, and in particular to a structure including an amorphous carbon film containing silicon and having an electrically conductive part and a method of manufacturing the same.

### BACKGROUND

Carbon black has conventionally been used as an electrode material for a battery (a conductive additive of a cathode active material). For example, acetylene black, which is a sort of carbon black, is used as an electrode material in a manganese battery. Among carbon blacks, acetylene black is made from a high purity acetylene gas and thus has following features. (1) Acetylene black is produced along with a large amount of heat and is highly crystalline among carbon blacks. (2) The content of impurities such as metals is small. (3) The gas produced during thermolysis only includes hydrogen, and the concentration of carbon is high; thus, carbon particles tend to collide and join together. Acetylene black exhibits a high electric conductivity with an intrinsic electric resistance of about ×10⁻¹ Ω·cm, and thus finds wide use as an electrically conductive material.

However, there are problems in production and utilization of carbon blacks including acetylene black. Here are examples of the problems. (1) High purity acetylene is required as a raw material gas. (2) The adiabatic attainment temperature caused by combustion of acetylene is as very high as 2600° C. (3) Acetylene black, which is microparticles, is difficult to handle (e.g., it needs to be slurried with a binder and applied and dried on a substrate). (4) Microparticles may adversely affect human bodies.

In contrast, an amorphous carbon film can be readily formed on the surface of a substrate by a known plasma process, etc. to have a high hardness, an excellent wear resistance, a small coefficient of friction, and a high capability of preventing adhesion of soft metals, serving as a gas barrier against H₂, H₂O, O₂, etc., and absorbing ultraviolet rays. These properties are provided to the surface of the substrate. Therefore, an amorphous carbon film is beginning to be used in various industrial fields, primarily in delivery feeders or carriers of small parts and handling trays. However, depending on the film forming conditions and raw materials, an amorphous carbon film has an electrical volume resistivity of about 10⁵ to 10⁶ Ω·cm and thus exhibits insulation quality. Therefore, it was difficult to apply it to applications requiring electric conductivity.

To overcome this problem, a method of providing electric conductivity to an amorphous carbon film has been proposed wherein graphite is formed on a part of the amorphous carbon film (see, e.g., Japanese Patent Application Publication No. 2012-84529). In this method, a part of the surface of the amorphous carbon film formed on the surface of a substrate is irradiated with a laser beam having an appropriate energy density, so as to modify the quality of the part of the amorphous carbon film irradiated with the laser beam and form graphite having electric conductivity.

Further, there has been provided a method of forming an electrically conductive region by applying an energy beam onto an insulating film such as an amorphous diamond film, a diamond-like film including a crystalline part, and a crystalline diamond film (see, e.g., Japanese Patent Application Publication No. Hei 10-261712). It is disclosed that, in this method, these films, which have high thermal conductivities, can increase heat emission capacity when used as insulating films.

Further, there have been proposed other methods wherein the amorphous carbon film is heated in a different way than in the above-described example to form an electrically conductive part. One example of such methods include introducing hydrocarbon into a vacuum chamber while producing plasma, depositing hydrocarbon radicals on the substrate, applying a negative high voltage pulse, and accelerating positive ions for application onto the substrate. Simultaneously, a positive high voltage pulse (0.5 to 15 kV) is applied onto the substrate such that electrons in the plasma are applied onto the substrate, whereby only the surface layer is activated in a pulsed manner and heated, and an amorphous carbon film having a high electric conductivity is deposited on the substrate (see, e.g., Japanese Patent Application Publication No. 2004-217975). Thus, in any of the above methods, the amorphous carbon film is heated and modified to have electric conductivity.

### SUMMARY

However, a typical amorphous carbon film does not have a sufficient thermal resistance against heating by a laser beam, etc., and thus a part irradiated with the laser beam and a surrounding thereof may be deteriorated and damaged by the thermal conductance, etc. For example, when the surface of an amorphous carbon film formed on a substrate is irradiated with a laser beam to depict a wiring part of a circuit having electric conductivity, the surrounding of the part (wiring part) irradiated with the laser beam may be deteriorated and damaged, thus degrading the electric circuit. More specifically, when the surrounding of the part irradiated with the laser beam is deteriorated to have electric conductivity, fine arrangement of wiring becomes impossible. Further, when the part having electric conductivity is to be subjected to physical friction (e.g., when this part is used on a contact part of a contact probe to be contacted with an inspection object), the deteriorated and damaged surrounding having a large area may impair the friction resistance and wear resistance normally expectable in the amorphous carbon film.

One object of the embodiments of the present invention is to form an electrically conductive part on an amorphous carbon film more appropriately. Another object of the embodiments of the present invention is to increase the friction resistance and wear resistance of the part surrounding the electrically conductive part of the amorphous carbon film. Other objects of the embodiments of the present disclosure will be apparent with reference to the entire description in this specification.

To produce a carbon black having a high electric conductivity such as acetylene black, a raw material containing less impurities such as metals (a high purity acetylene gas) is required. In contrast, an amorphous carbon film composed of hydrogen and carbon is formed by tentatively decomposing a hydrocarbon-based raw material gas such as acetylene in a plasma process evacuated with vacuum and including less impurities such as oxygen or atmosphere, and then depositing the amorphous carbon film composed of hydrogen and carbon. It can be expected that thus formed amorphous carbon film can be heated to obtain a carbon structure having a high electric conductivity such as acetylene black. However, much effort has not been made to produce a carbon black having electric conductivity by modifying the quality of an amorphous carbon film as a starting material intentionally containing impurities such as Si. The Inventor of the present invention has confirmed that the insulating quality of the amorphous carbon film containing Si is extremely higher than that of an amorphous carbon film composed of hydrogen and oxygen; but when irradiated with a laser beam, the amorphous carbon film containing Si obtains electric conductivity equivalent to that of the amorphous carbon film composed of hydrogen and carbon and not containing Si and, as compared to the case where the amorphous carbon film composed of hydrogen and carbon and not containing Si is irradiated with a laser beam, significantly less deterioration and damage occur in the surrounding of the laser-irradiated part. This is the motif of the present invention.

A structure according to an embodiment of the present disclosure may comprise a substrate and an amorphous carbon film containing Si formed on the substrate and at least partially including an electrically conductive part having electric conductivity.

A contact probe according to an embodiment of the present invention includes the above structure, wherein the electrically conductive part of the amorphous carbon film is formed on the contact part to be contacted with an inspection object. Also, a cell according to an embodiment of the present invention includes the above structure, wherein the amorphous carbon film is formed on an electrode and/or a separator. Further, an electronic component according to an embodiment of the present invention includes the above structure, wherein the electrically conductive part constitutes a circuit part.

The method of manufacturing the structure according to an embodiment of the present invention includes the steps of: preparing a substrate; forming on the substrate an amorphous carbon film containing Si; and heating the amorphous carbon film containing Si to form an electrically conductive part modified to have electric conductivity.

In various embodiments of the present invention, an electrically conductive part on an amorphous carbon film can be more appropriately formed, and the region surrounding the electrically conductive part of the amorphous carbon film can have increased friction resistance and wear resistance.

### BRIEF DESCRIPTION OF THE DRAWINGS

FIG. 1 is a schematic view schematically illustrating a section of a structure 10 according to an embodiment of the present invention.

FIG. 2 is a photograph of wiring formed on a substrate of Example 1.

FIG. 3 is a photograph of wiring formed on a substrate of Example 2.

### DESCRIPTION OF EXAMPLE EMBODIMENTS

Various embodiments of the present disclosure will now be described with reference to the attached drawings. In the drawings, the same or similar components are denoted by the same or similar reference signs, and the detailed description of the same or similar components is appropriately omitted.

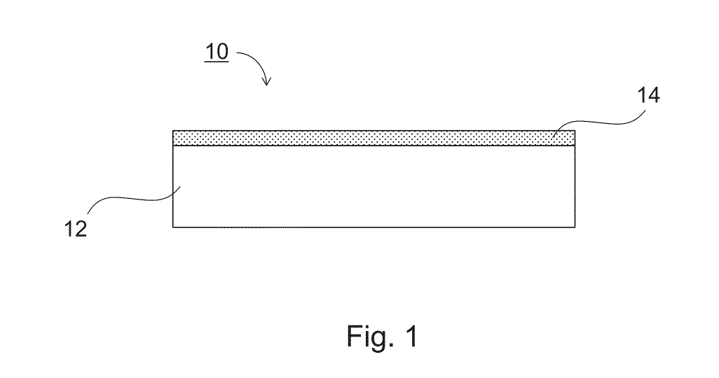

FIG. 1 is a schematic view schematically illustrating a section of a structure 10 according to an embodiment of the present invention. As shown, the structure 10 according to an embodiment may include a substrate 12 and an amorphous carbon film 14 containing Si formed on the substrate 12 and irradiated with a laser beam to have an electrically conductive part (not shown) modified to have electric conductivity. FIG. 1 schematically illustrates the structure 10 according to an embodiment of the present disclosure, and it should be noted that dimensional relationship is not accurately reflected in the drawing.

The substrate 12 according to an embodiment may be formed of various materials such as metals, semimetals such as Si, resins, ceramics, or cellulose. The substrate 12 may preferably be formed of a material heat-resistant against laser irradiation, and more specifically, a material that resists at least the allowable temperature limit of the amorphous carbon film (about 300° C.) and the temperature at which the amorphous carbon film becomes electrically conductive due to heat (about 400° C.). On the surface of the substrate 12 may be provided a coating process through wet plating, dry plating (various ceramic films provided by a plasma process, etc. and an electrically conductive amorphous carbon film containing B (boron), etc.), spray coating, or coating with a resin or rubber. The shape of the substrate 12 is not particularly limited and may be tabular, planar, solid, mesh-like, porous, film-like, etc. The surface roughness of the substrate 12 is also not particularly limited and may be desirably modified as necessary by various methods, e.g., physical processing such as blasting or buffing, chemical etching, or electrolytic polishing.

Conversely, the substrate 12 may be intentionally formed of a material having a relatively low allowable temperature limit (e.g., a resin such as PET). For example, a film-like structure 10 may include a substrate 12 formed of an insulating film resin (e.g., PET) and an amorphous carbon film 14 formed on the surface layer of the substrate 14. When such a structure 10 is irradiated with a laser beam at a desired part on the resin film side (the side of the substrate 12 where the amorphous carbon film 14 is absent), the resin film in the part irradiated with the laser beam may be readily melted and dissipated, and the amorphous carbon film 14 in the same part may be irradiated with the laser beam and modified to be electrically conductive (an electric conductor). Therefore, the structure 10 may include an insulating part and an electrically conductive part in the thickness direction (top-bottom direction) of the structure 10, as does an interposer substrate.

The amorphous carbon film 14 according to an embodiment may be formed by various methods such as plasma CVD methods, direct current CVD methods, plasma PVD methods such as plasma sputtering method, atmospheric and subatmospheric plasma methods. The amorphous carbon film 14 according to an embodiment should be modified to be electrically conductive by heating with application of a laser beam, and the amorphous carbon film may contain various different elements. Further, the unheated amorphous carbon film 14 according to an embodiment may preferably have a higher insulating quality than an ordinary amorphous carbon film composed of hydrogen and carbon or carbon only (hereinafter also referred to as “the ordinary amorphous carbon film”). Still further, the amorphous carbon film 14 according to an embodiment may preferably have a higher heat resistance and a lower thermal conductivity than, e.g., the ordinary amorphous carbon film. Accordingly, it may be preferable that the amorphous carbon film contain different elements or be formed by a specific film forming process for a higher insulating quality, a higher heat resistance, or a lower thermal conductivity. For example, the amorphous carbon film may contain nitrogen thereby to increase the heat resistance of the amorphous carbon film. This is because the C—N bond, having bonding energy of 175 kcal/mol, is more stable than the C—C bond, having bonding energy of 145 kcal/mol.

The amorphous carbon film 14 containing Si may be formed by the plasma CVD method, etc. using a raw material gas such as tetramethylsilane, methylsilane, dimethylsilane, trimethylsilane, dimethoxydimethylsilane, or tetramethylcyclotetrasiloxane. The amount of Si contained in the amorphous carbon film 14 is not particularly limited, but may preferably be 1 to 29 at. %, and may more preferably be 5 to 29 at. %. Since the Si content is 1 at. % or higher, it may be possible to reduce the internal stress of the amorphous carbon film 14 and prevent removal from the substrate 12. Further, since the Si content is 29 at. % or lower, it may be possible to restrain the increase of electric conductivity of the amorphous carbon film 14 and ensure the insulating quality thereof. In view of the above, it may be preferable that the amorphous carbon film 14 containing Si according to an embodiment be composed mainly of carbon (C), hydrogen (H), and silicon (Si), and the hydrogen (H) content be 20 to 40 at. % and the silicon (Si) content be 1 to 29 at. %.

The amorphous carbon film 14 according to an embodiment may contain Si thereby to restrain deterioration and damage of the surrounding of the part irradiated with a laser beam. Further, the amorphous carbon film 14 containing Si may have a high heat resistance even at the part irradiated with the laser beam, thereby restraining the part modified to be electrically conductive from brittle fracture and unwanted removal and scattering from the structure 10. Since the deteriorated and brittle part can be restrained from removing or scattering from the structure 10 during use of the structure 10, the structure 10 can be prevented from being a source of stain or unwanted electric conducting fractions (causing a short circuit) in the environment. Further, the part of the amorphous carbon film 14 according to an embodiment which is irradiated with the laser beam to be electrically conductive may be continuous to other parts not irradiated with the laser beam and thus maintaining solidity and tight adhesion to the substrate, even if the irradiation is finely made in the form of, e.g., honeycomb, lattice, or dots. Therefore, the electrically conductive part can be better restrained from removal from the structure 10 as compared to the case where a slurry including, e.g., acetylene black particles is applied later onto a substrate made of a different material to form the electrically conductive part.

The amorphous carbon film 14 containing Si may be modified due to laser irradiation over a smaller area than the ordinary amorphous carbon film not containing Si; therefore, a larger area of unmodified part can be retained where the inherent properties of the amorphous carbon film in the structure 10 can be achieved. Further, the electrically conductive part made electrically conductive by application of the laser beam onto the amorphous carbon film 14 according to an embodiment may be protected against external stresses by the surrounding unmodified parts of the amorphous carbon film which are not affected by the application of laser beam (heating) and retain adequate hardness and wear resistance. Therefore, durability of the structure 10 can be maintained, and the structure 10 can retain the properties of the amorphous carbon film.

The amorphous carbon film 14 containing Si according to an embodiment, which has lower heat conductivity than the ordinary amorphous carbon film, may have less tendency to conduct the heat produced by the laser application to the substrate 12, thereby restraining thermal deformation and damage of the substrate 12 caused by the laser application. Further, the amorphous carbon film 14 containing Si according to an embodiment may have an electrical volume resistivity three orders of magnitude larger than that of an amorphous carbon film composed of hydrogen and carbon; therefore, introduction of Si into the amorphous carbon film may reinforce the insulating quality of the amorphous carbon film. In the structure 10 including the amorphous carbon film 14 containing Si, the part surrounding the laser-irradiated part which is distant from the laser-irradiated part and is not directly heated can retain a higher insulating quality than that of the ordinary amorphous carbon film. That is, the structure 10 can include the minimized electrically conductive part and the reinforced insulator surrounding the electrically conductive part, as compared to the case where the ordinary amorphous carbon film is used When, e.g., the structure 10 is used as an electric circuit, the electric circuit (electric wiring) can be arranged more finely and can be subjected to higher voltages.

Further, in the amorphous carbon film 14 containing Si according to an embodiment, the adjacent part adjacent to the electrically conductive part modified to have electric conductivity may be subjected to the heat to the extent not to be modified to have electric conductivity. In this adjacent part, oxidation of Si may proceed in and under the surface layer of the amorphous carbon film, thereby further increasing the insulating quality of the amorphous carbon film 14 containing Si. It is conventional to apply a laser beam while using an oxygen-containing gas such as oxygen gas as an assist gas for a heating process (apply the gas to the substrate along with the laser beam), thereby further oxidizing the amorphous carbon film containing Si (or at least Si) to further increase the insulating quality. It should be noted that it is well known that a silicon oxide film layer such as SiOx has an insulating quality; and thus silicon oxide film layer is widely used as an insulating layer formed on a Si wafer in a semiconductor process.

When the ordinary amorphous carbon film not containing Si is formed directly on a substrate poorly adhesive to an amorphous carbon film, such as a substrate having a solid oxidize passive film formed in a surface layer by heating, or on a substrate to be used in severe heat cycles, practical use may often be impossible except the case where the adhesion to the substrate is significantly poor and the film is extremely thin. One example is a stainless steel screen mesh provided as a gas-permeable electrode in a fuel cell, wherein stainless steel is heated, drawn out, and made into wires that are then woven, and the surface thereof is intensely oxidized. Another example is a Ni plating screen mesh formed by electroforming using Ni plating or Ni alloy plating. Further, when the ordinary amorphous carbon film is formed to a large thickness on a substrate which is not poorly adhesive to the amorphous carbon film, the amorphous carbon film may be readily removed from the substrate due to internal stresses, making it difficult to form the amorphous carbon film to a large thickness. However, the amorphous carbon film containing Si may have smaller internal stresses and larger adhesion to the substrate than the ordinary amorphous carbon film, making it possible to form the amorphous carbon film to a large thickness. For example, on a stainless steel (SUS) substrate containing Cr and a Cr substrate that have satisfactory adhesion, the amorphous carbon film containing Si can be formed to a thickness larger than 5 μm. Further, in the case where the ordinary amorphous carbon film is formed on a substrate formed of Fe, etc., the carbon included in the amorphous carbon film may diffuse in the substrate, degrading the adhesion between the amorphous carbon film and the substrate. In contrast, the amorphous carbon film containing Si can suppress such a problem. Additionally, the amorphous carbon film composed of hydrogen and carbon contains carbon, and thus heating may cause hydrogen embrittlement. In contrast, the amorphous carbon film containing Si can suppress such a problem.

In the structure 10 according to an embodiment, the amorphous carbon film 14 may be a laminated film including the ordinary amorphous carbon film and the amorphous carbon film containing Si. The ordinary amorphous carbon film may be initially and continuously less adhesive to a substrate, particularly a ceramic substrate and a metal substrate having an oxidized passive film in the surface layer (poor durability of adhesion). On the other hand, the ordinary amorphous carbon film may have a high hardness and well prevent adhesion of soft metals. As compared to the ordinary amorphous carbon film, the amorphous carbon film containing Si may adhere well to metal substrates and ceramic substrates and have an excellent alkali resistance and insulating quality. On the other hand, the amorphous carbon film containing Si may have a lower hardness and require higher costs for, e.g., a material gas than the ordinary amorphous carbon film. The amorphous carbon film 14 according to an embodiment may be a laminated film including the amorphous carbon film containing Si as a first layer formed on the substrate 12 and the ordinary amorphous carbon layer as a second layer formed on the amorphous carbon film containing Si. Thus, the second layer positioned outside may be the ordinary amorphous carbon film which is hard and well prevents adhesion of soft metals, and the first layer on the substrate side may be the amorphous carbon film containing Si which tightly adheres to the substrate and well resists heat and drugs. These two layers may constitute composite layer structure wherein the advantages and disadvantages of the two layers complement each other. When the two layers in the composite layer are irradiated with a laser beam to form an electrically conductive part, the electrically conductive part may have the composite layer structure wherein the two layers complement each other, and the electrically conductive part may conduct electricity from outside the composite layer to the substrate side.

In the amorphous carbon film 14 according to an embodiment, when the Raman spectrum obtained by laser Raman spectroscopy at a part including the electrically conductive part modified by the heating has at least one symmetrical or asymmetrical peaks in at least one of three regions ranging between 1,200 cm⁻¹ and 1,450 cm⁻¹, between 1,350 cm⁻¹ and 1,550 cm⁻¹, and between 1,500 cm⁻¹ and 1,650 cm⁻¹, and has a peak in each of two regions ranging between 1,200 cm⁻¹ and 1,450 cm⁻¹ and between 1,500 cm⁻¹ and 1,650 cm⁻¹, it may be preferable that the intensities at the peaks in the two regions are higher than that at the peak in the region ranging between 1,350 cm⁻¹ and 1,550 cm⁻¹. On the other hand, when the Raman spectrum obtained by laser Raman spectroscopy at a part not modified by the heating has at least one symmetrical or asymmetrical peak or shoulder in at least one of three regions ranging between 1,200 cm⁻¹ and 1,450 cm⁻¹, between 1,350 cm⁻¹ and 1,550 cm⁻¹, and between 1,500 cm⁻¹ and 1,650 cm⁻¹, and has a peak in each of two regions ranging between 1,200 cm⁻¹ and 1,450 cm⁻¹ and between 1,500 cm⁻¹ and 1,650 cm⁻¹, it may be preferable that the intensities at the peaks in the two regions are lower than that at the peak in the region ranging between 1,350 cm⁻¹ and 1,550 cm⁻¹.

The structure 10 according to an embodiment can be effectively applied to an application where the electrically conductive part of the amorphous carbon film 14 is subjected to physical friction. In particular, the structure 10 according to an embodiment including the amorphous carbon film 14 having the composite layer structure can be very effectively applied to a contact part (contact point) positioned at the tip end of a contact probe used in an electric inspection apparatus for semiconductor circuits and plated printed circuits (e.g., a probe card for LSI); the contact part is to be contacted with an inspection object.

The tip end of the contact probe is very prone to adhesion by soft metals provided on the contact parts by, e.g., Sn plating. Such soft metals are included in: aluminum wiring and a pad in a semiconductor circuit which are formed of aluminum, a soft metal prone to adhesion; Cu wiring in a plated printed circuit which is formed of Cu, a soft metal; a pad and a land formed on the surface layer of the Cu wiring by flash Au plating for preventing oxidation; and external electrodes of a ceramic capacitor, inductor, and chip resistance. Therefore, if the contact probe is repeatedly contacted with the external electrodes of electronic components formed of soft metals, the soft metals may adhere and then oxidize in an oxidation atmosphere such as the atmosphere to produce metal oxides. As a result, the electric resistance of the contact point at the tip end of the contact probe may be varied, prohibiting accurate inspection. Therefore, conventional contact probes requires frequent removal of the soft metals and oxides thereof adhering to the contact point at the tip end.

As described above, the ordinary amorphous carbon film composed of hydrogen and carbon may well prevent adhesion of soft metals and have excellent wear resistance, but may exhibit the insulating quality; therefore, it is difficult to use such an amorphous carbon film in the contact point (contact current-carrying part) at the tip end of the contact probe. There are techniques of doping an amorphous carbon film with a metal element or B (boron) for increasing electric conductivity thereof; however, doping the film with a metal element may cause adhesion to soft metals, and boron is a dangerous and costly material gas. Further, an amorphous carbon film doped with a metal element or boron may not have an electric conductivity comparable to those of metals, thus restricting the applications as a contact probe.

In an embodiment, an amorphous carbon film 14 may have an electrically conductive part formed therein, thus enabling the structure 10 to be applied to a contact probe. More specifically, the structure 10 according to an embodiment including an amorphous carbon film 14 having the above-described composite layer structure may be applied to the contact part (the contact point at the tip end) to be contacted with an inspection object, so as to ensure the electric conductivity of the contact part, as well as tight adhesion to the substrate, the wear resistance, the friction resistance, and the capability of preventing adhesion of soft metals. That is, the second layer positioned outside (the ordinary amorphous carbon film) may ensure the wear resistance, the friction resistance, and the capability of preventing adhesion of soft metals, and the first layer positioned on the substrate side (the amorphous carbon film containing Si) may ensure tight adhesion to the substrate. Further, even if the part surrounding the laser-irradiated part of the second layer positioned outside is deteriorated (to have electric conductivity) or damaged, the first layer on the substrate side consisting of the amorphous carbon film containing Si may be restrained from being deteriorated or damaged; therefore, the composite layer as a whole can appropriately have electric conductivity, tight adhesion to the substrate, wear resistance, friction resistance, and capability of preventing adhesion of soft metals.

In the case where the structure 10 according to an embodiment is applied to a contact part (a contact point at the tip end) of a contact probe to be contacted with an inspection object, it may be effective to restrict the laser-irradiated spot to a very small area having a diameter of about 10 μm to 40 μm, or to apply the laser beam for modification (to provide electric conductivity) onto a part of the amorphous carbon film 14 formed on a side surface around the tip end portion of a needle-like probe rather than on the tip end portion to which an external pressure is applied by direct contact. The structure (shape) of the contact probe on which the amorphous carbon film 14 is formed may not be needle-like or protruding. The contact probe may be a rotator having a roller-like, ring-like, or spherical shape, and an amorphous carbon film 14 according to an embodiment may be formed on the surface layer of the contact probe and modified (to have electric conductivity) at a part thereof, so as to effectively disperse the surface pressure produced by contact.

The amorphous carbon film 14 containing Si according to an embodiment and the amorphous carbon film 14 containing oxygen and/or nitrogen in addition to Si includes in the surface layer thereof a large number of hydroxyl groups originating from Si, and thus has a good wettability for water and vapor in an atmosphere; therefore, a water film may tend to form on the amorphous carbon films under an ordinary state. Also, the amorphous carbon film 14 containing Si according to an embodiment can be heated to also facilitate oxidation of Si. Thus, the amorphous carbon film 14 can better suppress static electricity and remove electricity. The structure 10 according to an embodiment applied to a contact probe for inspection of electronic components can reduce failure of the electronic components due to static electricity occurring when the contact probe rubs against an object, thereby enhancing the performance of the electronic components.

Further, the structure 10 according to an embodiment can be effectively applied to an electrode and separator of a cell. Since an amorphous carbon film is corrosion resistant, it has been investigated whether it can be used on an electrode contacting an electrolyte (e.g., an aluminum electrode of an electric double layer capacitor) or used as a protection film of a separator in a corrosive cell. However, as described above, such uses are impractical because of the insulating quality of the amorphous carbon film. That is, in the case where the amorphous carbon film exhibiting the insulating quality is used as a protection film of an electrode or a separator, the amorphous carbon film should be formed to a thickness as small as about several tens of nanometers and conduct current by the tunnel effect. However, there are problems that an ohmic junction is not necessarily ensured, and that a thin amorphous carbon film may have lower corrosion resistance due to pinholes. In particular, the ordinary amorphous carbon film may have poor adhesion to the substrate, it may tend to be removed from the substrate after a while and thus have poor stability. Further, to ensure the corrosion resistance, the amorphous carbon film 14 should be formed to a large thickness so as to restrain the occurrence of pinholes in the amorphous carbon film and ensure the continuity of the film. However, when the thickness is large, the adhesion may be so degraded that the film may be removed from the substrate in the initial period and also the insulation quality may be increased, which makes it difficult to use the film as the protection film of an electrode or a separator. Still further, the ordinary amorphous carbon film is less resistant against, e.g., an alkaline solution (in an alkaline solution with pH of about 10 to 12, the ordinary amorphous carbon film may generate a white corrosion product in several hours). Thus, use of the ordinary amorphous carbon film as a protection film of an electrode or a separator is currently impractical. Such protection films may be formed as follows. Electrically conductive particles such as carbon black are dissolved (mixed) in a solvent; a binder is added as necessary, and the mixture is slurried, and applied to and dried on an electrode or separator. However, the adhesion and corrosion resistance of the slurry is insufficient, and additionally there are problems of difficulty in handling the particles and the adverse effects on human bodies, as described above.

An amorphous carbon film 14 according to an embodiment can be used as a protection film of an electrode or a separator so as to achieve excellent adhesion and corrosion resistance. That is, the amorphous carbon film containing Si, which may have better adhesion to the substrate and corrosion resistance than the ordinary amorphous carbon film, may include an electrically conductive part having electrical conductivity and may be used as a protection film of an electrode or a separator, thereby achieving a cell restraining the difficulty in handling the particles of carbon black and the adverse effects on human bodies. Such an amorphous carbon film 14 according to an embodiment can be formed to a large thickness so as to restrain the occurrence of pinholes in an electrode or a separator and maintain the continuity of the film, and a slurry of a carbon black such as acetylene black can be applied onto the amorphous carbon film 14, such that an electrolyte can be absorbed due to the high structure of the carbon black.

An electrode of a cell has been conventionally formed by applying a slurry of a carbon black such as acetylene black onto an aluminum foil. Thus, it is very important to increase adhesion and stability between the carbon black such as acetylene black and the slurry so as to improve the performance and life span of the cell. Meanwhile, it is known that the amorphous carbon film 14 containing Si placed in an oxidation atmosphere of the atmosphere or a liquid phase has a large amount of functional groups originating from Si such as hydroxyl groups generated on the surface layer of the film. Thus, the slurry of a carbon black such as acetylene black can be tightly and stably adhered to the aluminum foil substrate via a binder component (e.g., hydroxyl groups in a coupling agent) that will have a covalent bond or a hydrogen bond caused by condensation reaction with the functional groups formed on the surface layer of the amorphous carbon film 14 containing Si. That is, the amorphous carbon film 14 containing Si not only increases adhesion to the substrate 12; when used as the topmost layer (the outermost layer) of the laminated structure of the structure 10, it also facilitates junction of the structure 10 with outer objects, thus enabling another film to be formed for simple and stable modification and protection of structure 10.

When the structure 10 according to an embodiment having carbon black, etc. applied onto the amorphous carbon film 14 is used in an anode of a lithium ion secondary battery, etc., the carbon black, etc. including porous part or aggregate particles arrayed in the form of a chain or a bunch of grapes (structure) may act so as to mediate between active substances receiving and releasing lithium ions and restrict the variation in volume of these active substances. As a result, it may be possible to maintain the shape of the electrode even after repetition of discharging and recharging, secure the electricity conducting route, and restrain deterioration of the cell. Further, the surface layer of the amorphous carbon film 14 according to an embodiment may be covered with a protection film composed of a known hydrophobic coupling agent or fluorine-containing coupling agent that generates functional groups such as hydroxyl groups. The protection film may have such a small thickness (e.g., 10 nm to 20 nm) that it does not impede the electric conductivity. Thus, corrosion of the electrode and the separator may be further prevented.

The aluminum foil serving as a substrate for an electrode of the cell may have a passive insulating film of, e.g., oxidized aluminum naturally formed on the surface layer thereof when the foil is handled in an oxidation atmosphere such as the atmosphere. The passive insulating film may act to impede the electric conductivity of the electrode. It was difficult to prevent or restrain oxidation of the aluminum foil by the conventional method wherein the slurry of a carbon black such as acetylene black is applied in the atmosphere. In contrast, the amorphous carbon film 14 according to an embodiment may be formed by a vacuum process (in an environment where the surface layer of the aluminum foil is not oxidized); therefore, the amorphous carbon film 14 can be continuously formed as an oxidation-preventing layer against the atmosphere (H₂O and O₂ gas barrier layer), while stably ensuring the electric conductivity of the aluminum foil by removing or thinning the passive insulating layer on the surface layer of the aluminum foil in a vacuum with a sputtering gas such as Ar gas before the amorphous carbon film 14 is formed. As a result, after the amorphous carbon film 14 is formed, the oxidation of the aluminum foil substrate 12 can be prevented or restrained even when the structure 10 is used in the environment where the structure 10 is exposed to the atmosphere.

Further, the ordinary amorphous carbon film may have very poor adhesion to the aluminum foil. This is because aluminum as an electrode material has a larger coefficient of heat ray expansion than other metals, and there is a large difference from the ordinary amorphous carbon film in the coefficient of heat ray expansion (aluminum has a large coefficient of heat ray expansion, while the amorphous carbon film has a small one) and hardness (aluminum has a lower hardness, while the amorphous carbon film has a higher hardness and is subjected to a compression stress). For example, the ordinary amorphous carbon film formed on aluminum foil to a thickness of about 530 nm may be removed when taken out from the vacuum apparatus, while the amorphous carbon film 14 containing Si formed under the same condition on aluminum foil to a large thickness of about 700 nm is not removed when taken out from the vacuum apparatus. Such a phenomenon may be caused as follows. The aluminum foil which is heat-expanded to a high degree due to the heat produced by plasma when the amorphous carbon film is formed and the amorphous carbon film on the aluminum foil which is heat-expanded to a lower degree than the aluminum foil may be cooled when the atmospheric gas is introduced into the vacuum apparatus (when the aluminum foil and the amorphous carbon film are taken out), the aluminum rapidly contracts, whereas the amorphous carbon film expands on the aluminum foil due to the compression stress. The possibility of removal due to temperature change is very high in the combination of the aluminum foil and the ordinary amorphous carbon film.

The amorphous carbon film containing Si can be stably formed to a large thickness on metals or metal alloys having a larger coefficient of heat ray expansion than the amorphous carbon film such as aluminum foil included in an electrode of a cell. However, it was conventionally difficult to apply the amorphous carbon film containing Si due to a high insulating quality thereof. In contrast, according to an embodiment, the amorphous carbon film 14 containing Si in the structure 10 may have an electrically conductive part and thus can be applied as a protection film for the aluminum foil included in an electrode of a cell. The amorphous carbon film 14 containing Si in an embodiment and the amorphous carbon film containing oxygen in addition to Si may have a zeta potential on the surface which is significantly lower toward the negative side in an acidic solution; therefore, a high-performance electric double layer can be readily constructed. The amorphous carbon film 14 containing Si according to an embodiment can be heated to also facilitate oxidation of Si.

Further, the structure 10 in an embodiment can be used to form an electronic component. That is, the amorphous carbon film 14 may be formed in, e.g., a planar shape on the surface layer of the insulating substrate 12, and a circuit part may be depicted (formed) on the amorphous carbon film by a laser beam, thereby to form an electronic component including an insulating amorphous carbon film 14 and a circuit part formed thereon as an electrically conductive part having electric conductivity. In this case, in the amorphous carbon film 14 containing Si, the insulating quality is higher than that in the ordinary amorphous carbon film, and the area of the surrounding part deteriorated by application of the laser beam is small; therefore, an electronic circuit can be arranged more finely to a higher integration. The structure 10 in an embodiment wherein the amorphous carbon film 14 has the above-described composite layer structure may be used to form an electronic circuit. That is, the amorphous carbon film containing Si, in which adhesion to the substrate is good and the area of the surrounding part deteriorated by application of the laser beam is small, may be formed as a first layer on the substrate 12; the ordinary amorphous carbon film may be formed as a second layer on the amorphous carbon film containing Si; and the second layer (the ordinary amorphous carbon film which tends to be modified by the laser beam to have electric conductivity) may be irradiated with a laser beam to depict an electrically conductive circuit part. In this case, the output of the laser beam may be adjusted such that the first layer (the amorphous carbon film containing Si, which is less likely to be modified by the laser beam) serves as an insulating layer and substrate adhering layer. The composite layer structure of the amorphous carbon film 14 is not limited to the above-described double layer structure composed of the first layer and the second layer. For example, when an electrically conductive part is also formed in the first layer, the double layer structure may be repeated via insulating layers (e.g., insulating ceramic films such as SiOx or Al2Ox) to form a composite laminated structure. Additionally, an insulating substrate 12 may be formed of, for example, foil (anodized aluminum foil) formed by oxidizing aluminum by anodic oxidation to provide it with an insulating quality, a film-like sheet formed by applying onto a film a slurry composed of a dielectric such as ferrite or barium titanate, a film including a layer of metal oxide or Si oxide formed on the surface layer of a PET film, etc. by a plasma process or a sol-gel process. The composite structure may include the insulating substrate 12, the first layer (the amorphous carbon film containing Si), and the second layer, and this composite structure including the insulating substrate 12 may be repeated to form the composite laminated structure. Further, the composite structure including at least the first layer may additionally include another amorphous carbon film, a ceramic film, a metal film, a layer composed of an insulating resin or rubber, an electrically conductive resin layer such as pyrrole, or a piece of paper, etc. Still further, an electrically conductive part for collection or transmission may be provided on a desired position of the structure 10 having the composite structure described above.

When an electric circuit or wiring is formed using the structure 10 in an embodiment, no plating film or material including metal that are used in conventional circuit wiring is not used; therefore, short circuit caused by metal ion migration, etc. can be restrained, and degradation of the circuit caused by corrosion and deterioration due to oxidation can also be restrained.

The amorphous carbon film 14 containing Si in an embodiment can be formed on a wide range of materials with satisfactory adhesion; therefore, the amorphous carbon film 14 containing Si can provide electrically conductive wiring or an electrode part to materials not adapted for wet plating wiring such as paper, resin, and rubber, and materials prone to attack by pH of a wet plating bath (e.g., a capacitor composed of a ceramic material that cannot be plated in an acidic bath). Further, in forming a circuit, wiring can be directly depicted by a laser beam, eliminating the need of a mask having a reverse pattern to the circuit to be formed (e.g., a mask used in printing or etching the wiring), and also enabling appropriate formation of an electric circuit or wiring on a substrate 12 having a spheric surface or three-dimensional curved structure, a substrate 12 having a solid complex shape, and a very minute substrate 12 hard to have wiring formed thereon by masking.

In the structure 10 in an embodiment, another layer for various applications and purposes can be formed on the amorphous carbon film 14. For example, another amorphous carbon film may be formed to a small thickness for protection of the electrically conductive part having electric conductivity formed by applying a laser beam, or a plating film may be formed for wiring on the electrically conductive part (electrically conductive circuit wiring part) having electric conductivity formed by applying a laser beam. Likewise, various films such as a layer composed of a coupling agent, a layer composed of a resin adhesive, and a painting film can be formed to a thickness according to the application and the purpose thereof.

The methods of heating and modifying the amorphous carbon film 14 are not limited to application of a laser beam employed in an embodiment. For example, frictional heat may be employed for reaching a certain required temperature. In an embodiment, the type of the laser beam applied to heat the amorphous carbon film 14 is not limited as long as the laser beam can modify the amorphous carbon film 14 to be an electrically conductive part having electrical conductivity. The source of the laser beam may be, for example, YAG laser, argon laser, and excimer laser. The shape of the electrically conductive part on the amorphous carbon film 14 formed by applying the laser beam is also not limited. The electrically conductive part may have various shapes such as a line, a plane, dots, a single-stroke line, or an island, or curved surface or curved line on the surface layer of a three-dimensional substrate, or a linear shape in a glass tube substrate. In an embodiment, a laser beam is applied onto the amorphous carbon film 14 to form an electrically conductive part. Also, a method other than application of a laser beam can be used to heat the amorphous carbon film and provide electrical conductivity.

One example of the methods of heating the amorphous carbon film and providing electric conductivity by a method other than application of a laser beam may be, e.g., heating a desired portion of the amorphous carbon film in an oxygen-free atmosphere such as a vacuum to obtain an electrically conductive amorphous carbon film by combining the step of generating plasma of hydrocarbon and depositing it onto the substrate during formation of the amorphous carbon film and the step of applying electrons in the plasma to heat a desired part of the amorphous carbon film. However, the parts other than the part that is heated and modified to be electrically conductive may not necessarily retain the characteristic properties of typical amorphous carbon films such as wear resistance. In the structure 10 according to an embodiment, the amorphous carbon film 14 may be irradiated with a laser beam, such that only the desired part may be simply modified to be electrically conductive, and the parts of the amorphous carbon film not irradiated with the laser beam (not modified) may retain the properties of the typical amorphous carbon film and remain in the structure 10 as protection parts for the modified part against the external stresses. Thus, the amorphous carbon film 14 should preferably be heated by application of a laser beam. For example, the ordinary amorphous carbon film may have an allowable temperature limit of about 300° C. and, when the amorphous carbon film is heated on a hot plate under the atmospheric pressure and modified to have electric conductivity, the amorphous carbon film may be crystallized and disintegrated at about 500° C. Therefore, it is difficult to modify the ordinary amorphous carbon film to have electrical conductivity while maintaining the state where the properties of the amorphous carbon film can be achieved. In the structure 10 in an embodiment, heating of the amorphous carbon film 14 can be readily achieved in an operation environment having a room temperature and the atmospheric pressure by applying for a short time a laser beam selectively onto a limited small area (laser-irradiated part) only, such that the parts of the amorphous carbon film retaining the inherent properties thereof can readily remain in the amorphous carbon film 14.

In the structure 10 in an embodiment described above, the amorphous carbon film containing Si can be used to restrain the deterioration and loss of the part surrounding the laser-irradiated part as compared to the case where the ordinary amorphous carbon film formed on the substrate is irradiated with a laser beam to form the electrically conductive part. Therefore, the surrounding part can have an increased friction and wear resistance, insulating quality, and corrosion resistance; and the electrically conductive part of the amorphous carbon film can be formed more appropriately. Further, the amorphous carbon film 14 in an embodiment can be formed on substrates made of various substances and having various shapes with tight adhesion, which may not be achieved by a wet application method (physical adhesion method) wherein a slurried carbon black is applied, dried, and fixed on the substrate. Additionally, as compared to the case where a slurried carbon black is fixed by the wet application method, finer adjustment may be possible on the thickness of the film (e.g., adjustment in the units of nanometers), thereby increasing the uniformity of the thickness of the film.

### EXAMPLES

The structure 10 in an embodiment was examined for the electric conductivity of the electrically conductive part and the deterioration of the surrounding part by the following method.

1. Formation of Wiring (Electrically Conductive Part) on Amorphous Carbon Film

An amorphous carbon film composed of hydrogen and carbon was formed on a substrate of Si (100) to a thickness of about 550 nm using acetylene (intentionally at a low purity, which was 98% or higher) as a raw material gas by a known plasma CVD method. This amorphous carbon film was taken as Example 1. Another amorphous carbon film, containing Si, was formed on the same substrate to a thickness of about 550 nm using trimethylsilane as a raw material gas by a known plasma CVD method. This amorphous carbon film was taken as Example 2. Next, YAG laser (LDP-753-8AA from SHIBAURA MECHATRONICS CORPORATION) was used to form laser-irradiated wires on the surface layers of Examples 1 and 2. Each of the wires was 10 mm long and 10 μm wide and had rectangular pads at opposite ends. The laser beam was applied with the following conditions.

Frequency: 20 kHz

Assist gas: O₂, amount of Oxygen: 2 kgf/cm²

Rate: F60

Intervals: 9 μm

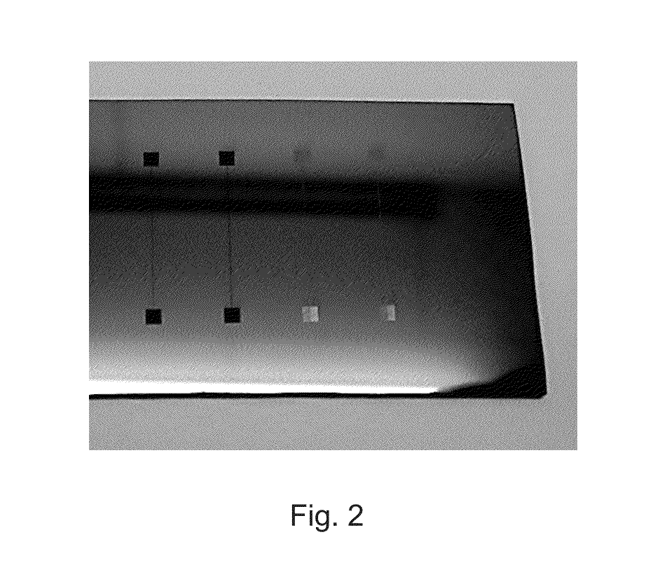

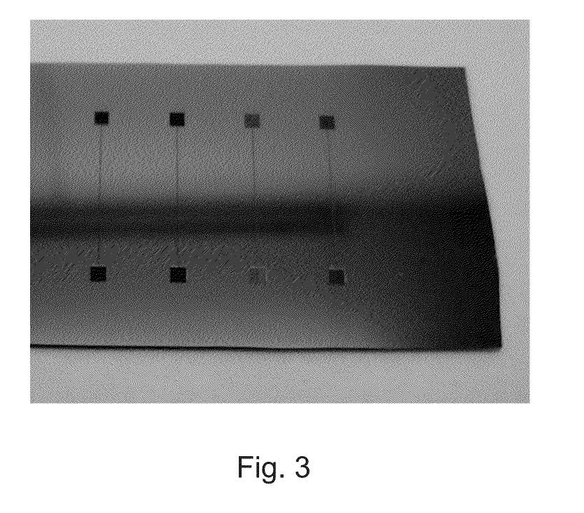

Examples 1 and 2 were irradiated with YAG laser at four output levels to form wiring. Examples 1 and 2 irradiated at “0.02 W-8.87 A” were taken as Examples 1-1 and 2-1, respectively. Examples 1 and 2 irradiated at “0.04 W-9.00 A” were taken as Examples 1-2 and 2-2, respectively. Examples 1 and 2 irradiated at “0.10 W-9.30 A” were taken as Examples 1-3 and 2-3, respectively. Examples 1 and 2 irradiated at “0.20 W-9.73 A” were taken as Examples 1-4 and 2-4, respectively. FIG. 2 shows a photograph of Examples 1-1 to 1-4. The photograph shown in FIG. 2 includes wires of Example 1-1 (0.02 W), Example 1-2 (0.04 W), Example 1-3 (0.10 W), and Example 1-4 (0.20 W) arranged from left to right. The intervals between adjacent wires are 5 mm. FIG. 3 shows a photograph of Examples 2-1 to 2-4. The photograph shown in FIG. 3 includes wires of Example 2-1 (0.02 W), Example 2-2 (0.04 W), Example 2-3 (0.10 W), and Example 2-4 (0.20 W) arranged from left to right. The intervals between adjacent wires are 5 mm. Examples 2-1 to 2-4 were examined for surface condition after application of the laser. None of these Examples included a part where deterioration or damage of the substrate (Si) was visually observed.

2. Measurement of Electrical Volume Resistivity of Wires (Electrically Conductive Parts)

Next, the electrical volume resistivity of each Example was measured. The measurement was conducted for each of the samples at a connection part between the rectangular pad at one end of the laser-irradiated part and the wire (laser-irradiated part) having a width of 10 μm and at a connection part between the rectangular pad at the other end of the laser-irradiated part and the wire (laser-irradiated part) having a width of 10 μm. The measurement results are shown below.

The apparatus used for the measurement was the High Precision Digital Multimeter 1281 from Wavetek. The measurement conditions were a temperature of 23±1° C. and a humidity of 50±5% in an electromagnetic measurement room (shield room). Direct current resistance was measured by four-terminal measurement method.

0.02 W Example 1-1: 2.41 kΩ, Example 2-1: 4.13 kΩ

0.04 W Example 1-2: 4.18 kΩ, Example 2-2: 5.67 kΩ

0.1 W Example 1-3: 6.36 kΩ, Example 2-3: 6.11 kΩ

0.2 W Example 1-4: 16.51 kΩ, Example 2-4: 18.06 kΩ

The largest electrical volume resistivity among Examples 1-1 to 1-4 was about 872 μΩ·cm; and the largest electrical volume resistivity among Examples 2-1 to 2-4 was about 996 μΩ·cm. Thus, all of Examples exhibited an electrical volume resistivity of less than 1 mΩ·cm, indicating that the laser-irradiated parts were modified to have a high electric conductivity.

3. Determination of Deterioration State of Surrounding Part Around Laser-Irradiated Part (Raman Spectrum Analysis)

Then, analysis was made on the relationship between the distance from the laser-irradiated part and the Raman spectrum. Analysis conditions were as follows.

Apparatus name: NRS-3300 from JASCO Corporation

Excitation wavelength: 514.53 nm

Exposure time: 30 sec

Grating: 1800 l/mm

First, Raman spectrum analysis was conducted on Example 1 (not irradiated with laser), Example 2 (not irradiated with laser), and the laser-irradiated parts of Example 1-1 and Example 2-1.

Each of the Raman spectra of the laser-irradiated parts of Example 1-1 and Example 2-1 exhibited intense and distinct Raman peaks around 1,330 cm⁻¹ (D band) and 1,580 cm⁻¹ (G band). Such Raman peaks were not observed in Example 1 (not irradiated with laser) or Example 2 (not irradiated with laser). The Raman spectra of Example 1-1 and Example 1-2 are similar to that of carbon black, and it can be supposed that electrically conductive carbon black is generated in the film. Additionally, it was observed that the intensity of the Raman peak around 1,330 cm⁻¹ (D band) was higher than that of the Raman peak around 1,580 cm⁻¹ (G band).

Next, the Raman spectra were measured in Example 1-4 and Example 2-4. This measurement was conducted in the rectangular pads included in the laser-irradiated parts and at positions included in the parts not irradiated with the laser beam which were distant from the pads at regular intervals and arranged straightly toward the outer side of the substrate. Then, it was examined which of the films of Example 1-4 and Example 2-4 was deteriorated to a farther point from the laser-irradiated parts. The state of deterioration was determined based on occurrence or variation of the Raman peaks mainly around 1,330 cm⁻¹ (D band) and 1,580 cm⁻¹ (G band).

### Example 1-4

The Raman spectrum was measured on Example 1-4 at a position 8 μm distant from the laser-irradiated part which is not irradiated with the laser beam. A shoulder-like peak was observed around 1,330 cm⁻¹ (D band), indicating initiation of deterioration of the film. Next, the spectrum was measured at a position 7.8 μm distant from the laser-irradiated part. A larger peak was observed around 1,330 cm⁻¹ (D band), indicating further deterioration of the film.

### Example 2-4

Then, the Raman spectrum was measured on Example 2-4 at a position 5 μm distant from the laser-irradiated part. The observed waveform was almost the same as that observed in the part not irradiated with the laser beam, indicating no deterioration of the film. Next, the spectrum was measured at a position 2.7 μm distant from the laser-irradiated part. There was no variation of the waveform around 1,330 cm⁻¹ (D band) and 1,580 cm⁻¹ (G band) except for slightly upward inclinations. Further, the spectrum was measured at a position 2.6 μm distant from the laser-irradiated part. A weak peak appeared around 1,580 cm⁻¹ (G band), indicating deterioration of the film. The above results can be summarized as follows. The region of the amorphous carbon film of Example 1 deteriorated by application of the laser beam was so large as to reach a distance more than about three times as large as that reached by the deteriorated region of the amorphous carbon film containing Si of Example 2.

Likewise, analysis was made on the relationship between the distance from the laser-irradiated part and the Raman spectrum in Example 1-1 and Example 2-1. Deterioration of the films was observed at the position 4 μm distant in Example 1-1 and at the position 4 μm distant in Example 1-2. Based on the above result, the area deteriorated by the heat of the applied laser is smaller in Example 2 than in Example 1.

Based on the above results of the Raman spectrum analysis on Examples 2 and 2-1 to 2-4 including the amorphous carbon films containing Si, the Raman spectrum obtained by laser Raman spectroscopy at unmodified parts (parts which is not deteriorated by heat of the laser beam) exhibited a waveform having one relatively synchronous peak between 1,350 cm⁻¹ and 1,550 cm⁻¹. In contrast, when the Raman spectrum obtained by laser Raman spectroscopy at a part modified by the heating, that is, an electrically conductive part (the laser-irradiated part), and a part having electricity conducting quality (the heat-deteriorated part around the laser-irradiated part) has at least one symmetrical or asymmetrical peak in at least one of three regions ranging between 1,200 cm⁻¹ and 1,450 cm⁻¹, between 1,350 cm⁻¹ and 1,550 cm⁻¹, and between 1,500 cm⁻¹ and 1,650 cm⁻¹, and has a peak in each of two regions ranging between 1,200 cm⁻¹ and 1,450 cm⁻¹ and between 1,500 cm⁻¹ and 1,650 cm⁻¹, it was observed that the intensities at the peaks in the two regions are higher than that at the peak in the region ranging between 1,350 cm⁻¹ and 1,550 cm⁻¹.

4. Determination of Modification State in Laser-Irradiated Part

Next, the rectangular pads (laser-irradiated part) of Example 1-1 and Example 2-1 were observed in an enlarged CCD camera photograph. The laser-irradiated part of the Example 1-1 was entirely modified to be black, whereas the laser-irradiated part of Example 2-1 included a large number of parts similar to the parts not irradiated with the laser beam (apparently unmodified parts) scattered among the parts modified to be black. That is, Example 2 resisted laser application and exhibited the same electric conductivity as Example 1. The apparently unmodified parts in Example 2-1 consist of the parts modified to be brittle electric conductors by application of the laser beam so as to be less prone to be removed from the amorphous carbon film. The degree of damage of the amorphous carbon films caused by application of the laser beam can be confirmed by, e.g., comparing the results of the Raman spectrum analysis of Example 1-1 and Example 1-2 as follows. The analysis result for Example 1-1 indicated that the peak intensity around 980 cm⁻¹ representing Si (100) included in the substrate was higher than those around 1,330 cm⁻¹ (D band) and around 1,580 cm⁻¹ (G band); and the analysis result for Example 1-2 indicated that the peak intensity around 980 cm⁻¹ was significantly lower than those around 1,330 cm⁻¹ (D band) and around 1,580 cm⁻¹ (G band). Thus, it can be likewise confirmed that the damage on Example 1 was larger than that on Example 2.

5. Determination of Deterioration State in Surrounding Part Around Laser-Irradiated Part (Detection of Oxygen Atom)

Next, amount of oxygen was detected to determine the oxidation state in Example 1-1 and Example 2-1. The detection was conducted in the rectangular pads included in the laser-irradiated parts which did not undergo the Raman spectrum analysis and were positioned opposite to those which underwent the Raman spectrum analysis and at positions included in the parts not irradiated with the laser beam which were distant form the laser-irradiated part at regular intervals and arranged straightly toward the outer side of the substrate. The same measurement was conducted on Si (100) samples, Example 1 (no laser irradiation) and Example 2 (no laser irradiation), which were prepared at the same time and under the same conditions as Example 1 and Example 2, respectively. The measurement was conducted under the following conditions.

Measurement apparatus: FE-SEM SU-70 (from Hitachi High-Technologies Corporation)

Measurement conditions: acceleration voltage 5.0 kV, current mode: Med-High, scale factor: 2,000

The results of measurement of detected oxygen atoms (at. %) were as follows.

### Example 1-1

1) The laser-irradiated part: 35.41%

2) The part not irradiated with the laser beam and 2 μm distant from the laser-irradiated part: 6.67%

3) The part not irradiated with the laser beam and 20 μm distant from the laser-irradiated part: 4.09%

4) No laser irradiation: 0.7%

### Example 2-1

1) The laser-irradiated part: 48.45%

2) The part not irradiated with the laser beam and 1 μm distant from the laser-irradiated part: 21.99%

3) The part not irradiated with the laser beam and 3 μm distant from the laser-irradiated part: 5.2%

4) The part not irradiated with the laser beam and 20 μm distant from the laser-irradiated part: 4.62%

5) No laser irradiation: 2.43%

Thus, in both Examples 1-1 and 2-1, larger amounts of oxygen were detected in the parts irradiated with the laser beam and the surrounding part therearound than in samples not irradiated with the laser beam, indicating advancement of oxidation.

6. Determination of Surface Electric Resistivity

An ordinary amorphous carbon film composed of hydrogen and carbon was formed on a substrate of Si (100) to a thickness of about 550 nm using acetylene as a raw material gas by a known direct current pulsed plasma CVD apparatus. This amorphous carbon film was taken as Example 3. Another amorphous carbon film, containing Si, was formed on the same substrate to a thickness of about 550 nm using trimethylsilane as a raw material gas by the same plasma CVD apparatus. This amorphous carbon film was taken as Example 4. The films of Examples 3 and 4 were formed under the same conditions such as ultimate pressure, flow rate of the raw material gas, gas pressure, voltage applied to the work. Next, the surface electric resistivity of Examples 3 and 4 was measured as surface resistance by the double ring method (constant voltage constant current measurement method).

The measurement apparatuses were High Resistance Meter 4339B from Agilent Technologies, and Resistivity Cell 16008B from Agilent Technologies, used with the following conditions.

Main electrode size: 26 mmφ

Inner diameter of electrode couple: 38 mmφ

Card electrode: 110 mm×110 mm

Load: 1 kgf

The measurement conditions were a temperature of 23±1° C. and a humidity of 50±5% in an electromagnetic measurement room (shield room).

The measurement results of the surface resistivity at a test voltage of 10 V were 2.9×10⁹ Ω/□ for Example 3 and 1.6×10¹² Ω/□ for Example 4, indicating that Example 4 had extremely higher insulating quality than Example 3.

7. Other

Next, it was confirmed that an additional amorphous carbon film can be formed on Examples 1-1 to 1-4 and Examples 2-1 to 2-4 carried by respective substrates by a known plasma CVD method. Specifically, the substrates of Examples 1 and 2 were placed on the sample table in the DC pulsed plasma CVD apparatus, the apparatus was evacuated with vacuum to 1×10⁻³ Pa, then C₂H₂ gas was introduced to a flow rate of 30 SCCM and a gas pressure of 1.5 Pa, and an amorphous carbon film was formed over the entire surface of the substrates carrying 20 nm thick Examples 1-1 to 1-4 and Examples 2-1 to 2-4 with an applied voltage of −3 kVp, a pulse frequency of 10 kHz, and a pulse width of 1 μs, thus confirming that an amorphous carbon film can be formed on the laser-irradiated part.

What is claimed is:

1. A structure comprising:
a substrate; and
an amorphous carbon film containing Si formed on the substrate and having at least partially an electrically conductive part modified to have electric conductivity by heating.

2. The structure of claim 1 wherein the electrically conductive part is modified to have electric conductivity by application of a laser beam.

3. The structure of claim 1 wherein the amorphous carbon film includes an adjacent part adjacent to the electrically conductive part and oxidized by heating.

4. The structure of claim 1, wherein a Raman spectrum of the amorphous carbon film obtained by laser Raman spectroscopy at a part including the electrically conductive part and modified by the heating has at least one symmetrical or asymmetrical peak in at least one of three regions ranging between 1,200 cm⁻¹ and 1,450 cm⁻¹, between 1,350 cm⁻¹ and 1,550 cm⁻¹, and between 1,500 cm⁻¹ and 1,650 cm⁻¹, and when the Raman spectrum has a peak in each of two regions ranging between 1,200 cm⁻¹ and 1,450 cm⁻¹ and between 1,500 cm⁻¹ and 1,650 cm⁻¹, intensities at the peaks in the two regions are higher than that at the peak in the region ranging between 1,350 cm⁻¹ and 1,550 cm⁻¹.

5. The structure of claim 1, wherein a Raman spectrum of the amorphous carbon film obtained by laser Raman spectroscopy at a part not modified by the heating has at least one symmetrical or asymmetrical peak or shoulder in at least one of three regions ranging between 1,200 cm⁻¹ and 1,450 cm⁻¹, between 1,350 cm⁻¹ and 1,550 cm⁻¹, and between 1,500 cm⁻¹ and 1,650 cm⁻¹, and when the Raman spectrum has a peak in each of two regions ranging between 1,200 cm⁻¹ and 1,450 cm⁻¹ and between 1,500 cm⁻¹ and 1,650 cm⁻¹, intensities at the peaks in the two regions are lower than that at the peak in the region ranging between 1,350 cm⁻¹ and 1,550 cm⁻¹.

6. The structure of claim 1 wherein the electrically conductive part has electric conductivity with an electrical volume resistivity of less than 1 mΩ·cm.

7. The structure of claim 1 wherein the amorphous carbon film is a laminated film comprising a first amorphous carbon film containing Si formed on the substrate and a second amorphous carbon film not containing Si formed on the first amorphous carbon film.

8. The structure of claim 1 wherein the amorphous carbon film contains O and/or N in addition to Si.

9. The structure of claim 1 wherein the amorphous carbon film contains 1 to 29 at. % Si.

10. A contact probe comprising the structure of claim 1, wherein the electrically conductive part of the amorphous carbon film is positioned on a contact part to be contacted with an inspection object.

11. A cell comprising the structure of claim 1, wherein the amorphous carbon film is positioned on an electrode and/or a separator.

12. An electronic component comprising the structure of claim 1, wherein the electrically conductive part is included in a circuit part.

13. A method of manufacturing a structure, comprising the steps of:
preparing a substrate;
forming on the substrate an amorphous carbon film containing Si; and
heating the amorphous carbon film containing Si to form an electrically conductive part modified to have electrical conductivity.
